(19) United States
(12) Patent Application Publication
(10) Pub. No.: US 2023/0212969 A1
(43) Pub. Date: Jul. 6, 2023

(54) Exhaust gas liquefying device

(71) Applicant: Denis Dufort, Ste-Julie (CA)

(72) Inventor: Denis Dufort, Ste-Julie (CA)

(21) Appl. No.: 18/085,464

(22) Filed: Dec. 20, 2022

(30) Foreign Application Priority Data
Dec. 30, 2021 (GB) 2119131.7

(51) Int. Cl. F01N 3/00; F01N 3/05; F01N 3/02; F01N 3/038; F01N 3/28; B01D 53/00; B01D 53/94

(52) U.S. Cl. CPC F01N 3/005; F01N 3/05; F01N 3/0205; F01N 3/038; F01N 3/28; B01D 53/002; B01D 53/94

(57) ABSTRACT

An exhaust gas liquefying device is provided for reducing pollution from vehicles includes a casing generally comprised of two interconnected chambers. The casing is attached to the rear portion of a vehicle such as a car or small truck. The casing has an entry port to collect the exhaust gas from an exhaust pipe coming from the vehicle. At least one fan provides additional air and a condenser coil cools down the exhaust gas into a liquid which precipitates the carbon in the carbon dioxide. The added ambient air provided by the fan helps in evaporating the liquid which exits from an evacuation port.

### CROSS-REFERENCE TO RELATED APPLICATIONS

The present application claims priority to request GB2119131.7, filed on Dec. 30, 2021, the disclosure of which is hereby incorporated in its entirety at least by reference.

### BACKGROUND OF THE INVENTION

### 1. Field of the Invention

The present invention relates generally to exhaust processing equipment but more particularly to an exhaust gas liquefying device.

### 2. Description of Related Art

Air pollution caused by vehicle exhaust is a major problem. One way to mitigate the problem is to sequester those gases. Capturing exhaust from fixed buildings such as factories or power plants is easy because they are fixed in one location and can have complex scrubbing system to handle flu gases. However, for a moving vehicle, it can be more difficult. One way to solve the problem is to turn the gas into a liquid which is more manageable.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In one aspect of the invention, an exhaust gas liquefying device is provided, comprising a first chamber configured to receive exhaust gas from a vehicle via an exhaust entry port, wherein the exhaust gas comprises carbon dioxide and carbon monoxide; a second chamber in fluid communication with the first chamber, wherein the second chamber is configured to receive the exhaust gas from the first chamber; a condenser unit provided in the second chamber, the condenser unit is configured to convert the exhaust gas to a liquid condensate via condensation such that the condenser unit precipitates carbon from the carbon dioxide and the carbon monoxide; a fan provided in the second chamber, the fan configured to aid in the evaporation of the liquid condensate to a gas free of carbon, wherein the gas exists the device to the atmosphere via an evacuation port.

In one embodiment, the first chamber is a gas expansion chamber and the second chamber is a mixing chamber. In one embodiment, a control valve configured to adjust a dilution ration of fresh air versus exhaust gas into the mixing chamber is provided. In another embodiment, one or more perforated sections are provided in the gas expansion chamber to prevent heat loss within the gas expansion chamber. In another embodiment, an exhaust deflector is provided preventing heat from the exhaust gas from affecting the fan. In one embodiment, the gas expansion chamber is separated from the mixing chamber via a partitioning member.

In another aspect of the invention, an exhaust gas liquefying device is provided, comprising a plurality of exhaust entry ports configured to receive exhaust gas from a diesel vehicle, wherein the exhaust gas comprises carbon; a condenser unit; at least one catalytic module is provided at an end of at least one exhaust entry port of the plurality of exhaust entry ports, wherein the catalytic modules are configured to capture diesel molecules from the exhaust gas as the exhaust moves into the condenser unit; and, a radiator configured to cool the temperature of the exhaust gas.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a perspective view of the exhaust gas liquefying device according to an embodiment of the present invention.

FIG. 2 is an exploded view of the exhaust gas liquefying device according to an embodiment of the present invention.

FIG. 3 is an isometric view of the exhaust gas liquefying device according to an embodiment of the present invention.

FIG. 4 is a cutaway sectional side view of the exhaust gas liquefying device according to an embodiment of the present invention.

FIG. 5 is a cutaway view of a second exhaust gas liquefying device according to an embodiment of the present invention.

FIG. 6 is a sectional isometric view of FIG. 5.

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide an exhaust gas liquefying device.

It is to be understood that the terminology used herein is for the purpose of describing particular embodiments only and is not intended to be limiting. The terms “a” or “an,” as used herein, are defined as to mean “at least one”. The term “plurality,” as used herein, is defined as two or more. The term “another,” as used herein, is defined as at least a second or more. The terms “including” and/or “having,” as used herein, are defined as comprising (i.e., open language). The term “coupled,” as used herein, is defined as connected, although not necessarily directly, not necessarily mechanically, and not permanent. The term “providing” is defined herein in its broadest sense, e.g., bringing/coming into physical existence, making available, and/or supplying to someone or something, in whole or in multiple parts at once or over a period of time. As used herein, the terms “about”, “generally”, or “approximately” apply to all numeric values, whether or not explicitly indicated. These terms generally refer to a range of numbers that one of skill in the art would consider near the stated amount by about 0%, 5%, or 10%, including increments therein. In many instances these terms may include numbers that are rounded to the nearest significant figure.

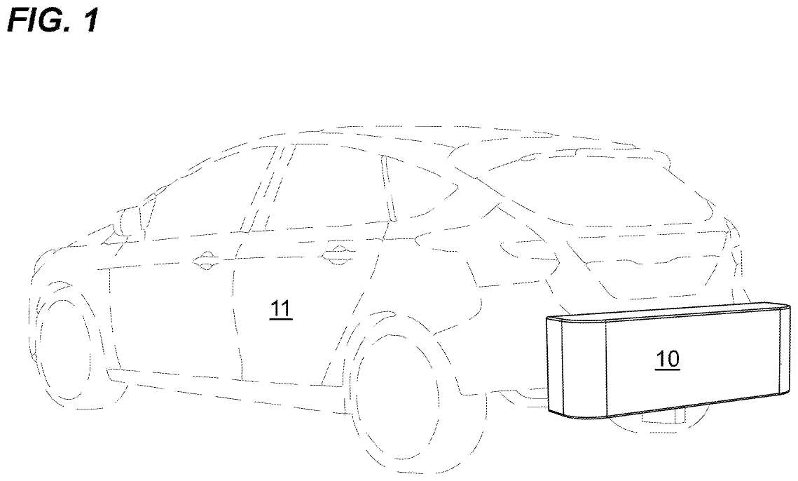

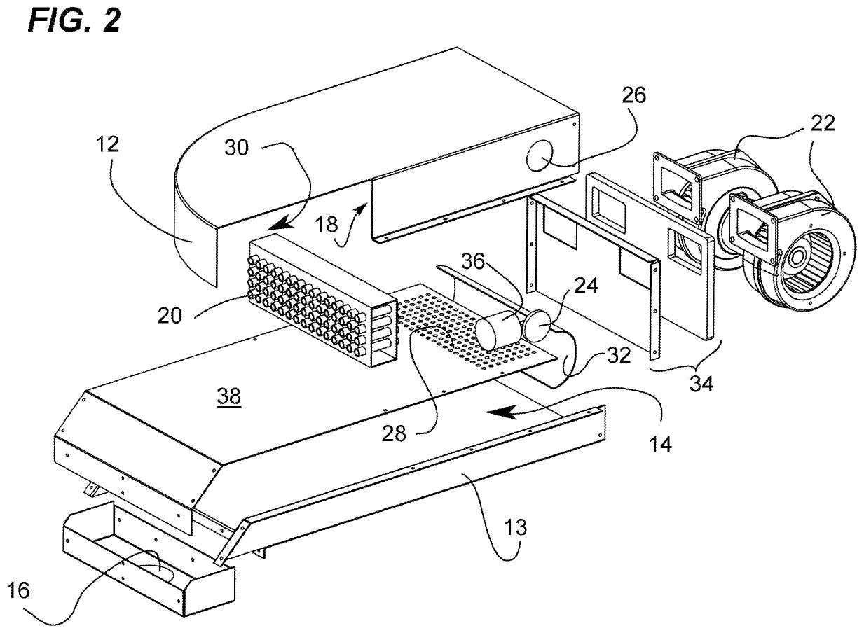

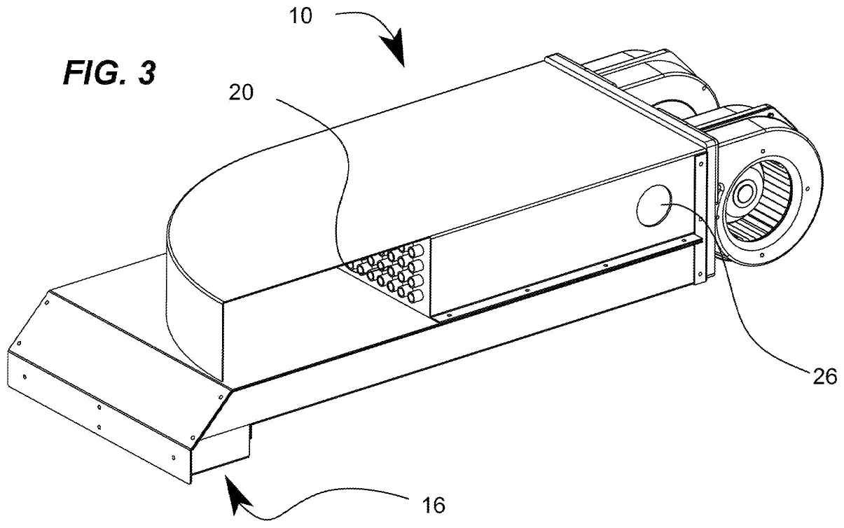

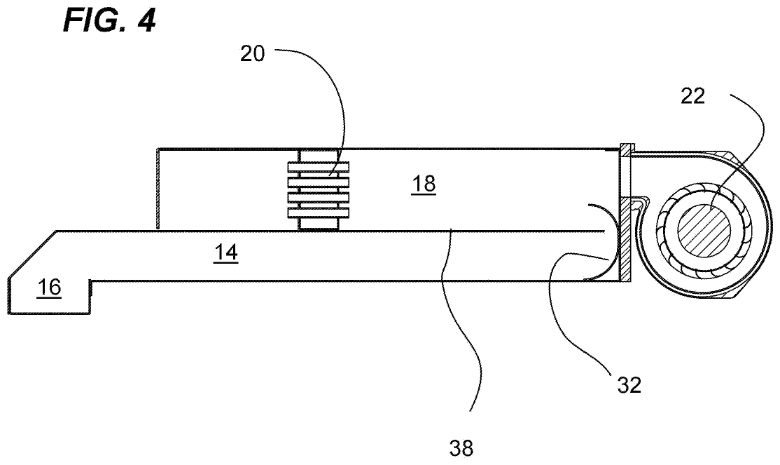

Referring now to any of the accompanying FIGS. 1-4, an exhaust gas liquefying device 10 is provided and which can be attached to a vehicle 11. In one embodiment, the exhaust gas liquefying device 10 comprises a cover panel 12 and a back panel 13 and is generally comprised of a first and a second chamber, wherein the first chamber is a gas expansion chamber 14 which takes on the vehicle's exhaust by way of an exhaust entry port 16. The exhaust then transfers into the second chamber which is a mixing chamber 18.

In one embodiment, the mixing chamber 18 includes a condenser unit 20 and at least one fan 22. In some embodiments, two or more fans are provided, to accelerate the evaporation during use after the initial condensation via the condenser unit 20, which will be discussed in further details below.

During use, since a vehicle typically changes speed, the amount of exhaust coming out is irregular and can affect the performance of the condensation process. In order to compensate for those fluctuations, a control valve 24 is provided, wherein the control valve 24 provides additional air by way of an opening 26 in order to adjust the pressure according to the flow rates at play, and to maintain the desired dilution ratio of fresh air vs exhaust gas. The air from the valve 24 is drawn in by way of the Venturi effect created by the air movement inside the mixing chamber 18, as created by the at least one fan 22.

Advantageously, to avoid too much heat loss in the expansion chamber 14, during the premixing step in the gas expansion chamber 14, the contact zone is constrained by the addition of a perforated section 28 to allow for a gradual mixing.

Upon entering the mixing chamber 18, the additional air coming from the at least one fan 22 increases pressure in that area, which forces condensation as the mixture of air and exhaust has to pass through the constrained passages made through the condenser unit 20. This precipitates the carbon out of the exhaust. The condensate is then returned into gas form on the other side of the condenser unit 20 when the pressure drops and expansion occurs. The resulting gas then exits via an evacuation port 30.

The exhaust gas liquefying device 10 further includes an exhaust deflector 32 which prevents heat from affecting the at least one fan 22, a two layered end panel 34, a motor 36 to control the opening/closing of the valve 24, and a partitioning member 38 to separate the exhaust chamber 14 from the mixing chamber 18. In some embodiments, the valve 24 and/or motor 36 is controlled by a CPU, and one or more sensors (not illustrated).

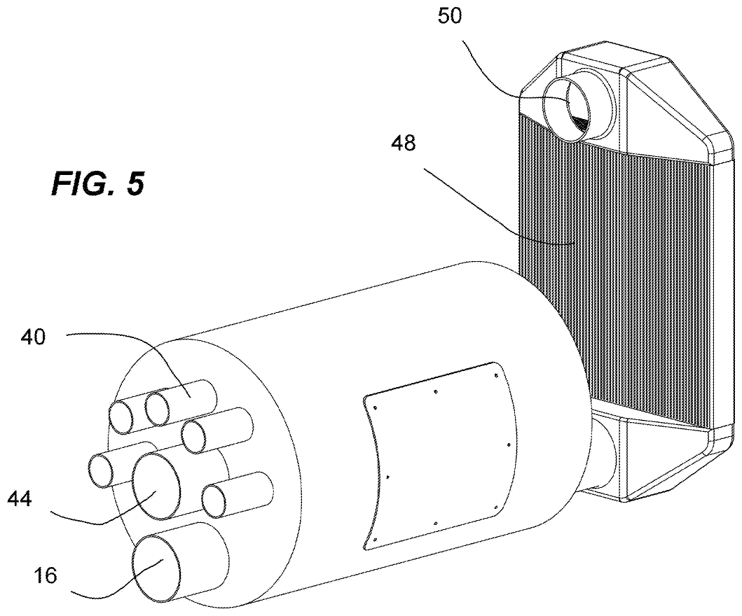

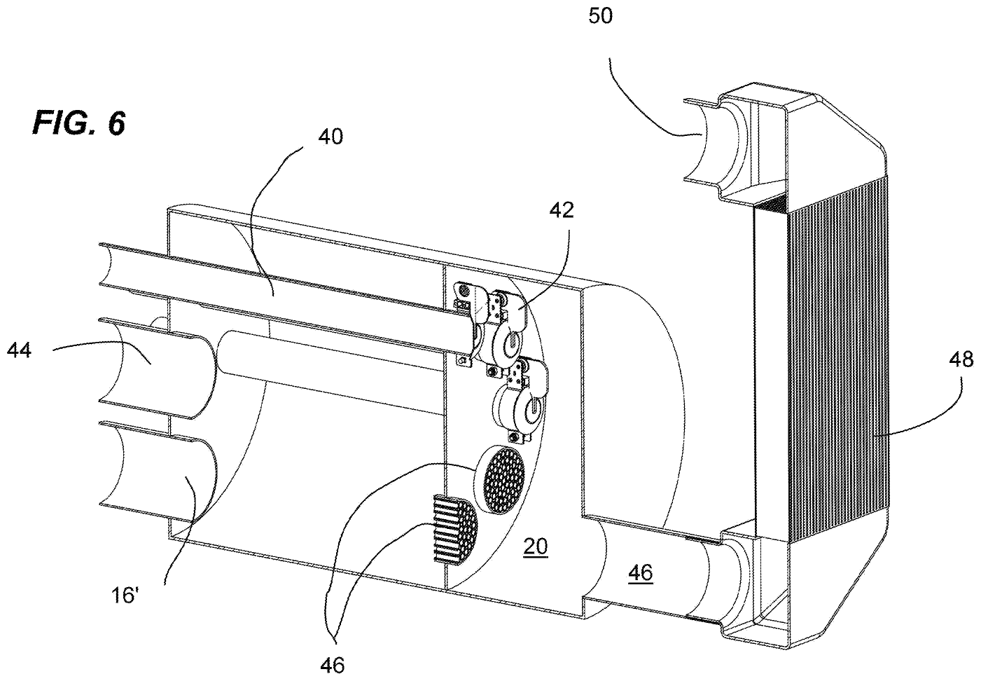

The preceding embodiment is optimized for gasoline while the following alternate embodiment, as seen in FIGS. 5-7 is best suited for diesel fuel. Referring now to FIGS. 5-7, the alternative exhaust gas liquefying device comprises a plurality of air entry pipes 40 (5 shown in this example). These air entry pipes 40 only work when the vehicle is moving up to around 100 kph. In some embodiments, their ends are capped with check valves 42. The air enters the condenser unit to increase its pressure.

There is an exhaust entry port 16′ and a forced air entry point 44 which has air forced in by a fan (not shown) similar to the fan 22 seen in the embodiment of FIGS. 1-4. Catalytic modules 48 at the end of the exhaust entry port 16′ capture the diesel molecules as the exhaust moves into the condenser unit 20. The exhaust exits the condenser unit 20 by way of a passage 46 which leads to a radiator 48 that cools down the exhaust gas by way of a heat exchange with ambient air coming from an air inlet 50.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. An exhaust gas liquefying device comprising:
a first chamber configured to receive exhaust gas from a vehicle via an exhaust entry port, wherein the exhaust gas comprises carbon dioxide and carbon monoxide;
a second chamber in fluid communication with the first chamber, wherein the second chamber is configured to receive the exhaust gas from the first chamber;
a condenser unit provided in the second chamber, the condenser unit is configured to convert the exhaust gas to a liquid condensate via condensation such that the condenser unit precipitates carbon from the carbon dioxide and the carbon monoxide;
a fan provided in the second chamber, the fan configured to aid in the evaporation of the liquid condensate to a gas free of carbon, wherein the gas exists the device to the atmosphere via an evacuation port.

2. The exhaust gas liquefying device of claim 1, wherein the first chamber is a gas expansion chamber and the second chamber is a mixing chamber.

3. The exhaust gas liquefying device of claim 2, further comprising a control valve configured to adjust a dilution ration of fresh air versus exhaust gas into the mixing chamber.

4. The exhaust gas liquefying device of claim 2, wherein one or more perforated sections are provided in the gas expansion chamber to prevent heat loss within the gas expansion chamber.

5. The exhaust gas liquefying device of claim 2, further providing an exhaust deflector preventing heat from the exhaust gas from affecting the fan.

6. The exhaust gas liquefying device of claim 2, wherein the gas expansion chamber is separated from the mixing chamber via a partitioning member.

7. An exhaust gas liquefying device comprising:
a plurality of exhaust entry ports configured to receive exhaust gas from a diesel vehicle, wherein the exhaust gas comprises carbon;
a condenser unit;
at least one catalytic module is provided at an end of at least one exhaust entry port of the plurality of exhaust entry ports, wherein the catalytic modules are configured to capture diesel molecules from the exhaust gas as the exhaust moves into the condenser unit; and,
a radiator configured to cool the temperature of the exhaust gas.
